(19) United States
(12) Patent Application Publication
(10) Pub. No.: US 2006/0053050 A1
(43) Pub. Date: Mar. 9, 2006

(54) Method for rating an advertisement

(75) Inventor: Rene Schweier, Stuttgart (DE)

Correspondence Address: DREISS, FUHLENDORF, STEIMLE & BECKER, POSTFACH 10 37 62, D-70032 STUTTGART, DE

(73) Assignee: HURRA Communications GmbH, Stuttgart (DE)

(21) Appl. No.: 10/935,116

(22) Filed: Sep. 8, 2004

(51) Int. Cl. G06Q 30/00; G07G 1/00

(52) U.S. Cl. 705/14; 705/10; 705/26

(57) ABSTRACT

To optimise an advertisement, that is displayed to a purchaser, e.g. by broadcasting the advertisement via radio or television, or by publishing the advertisement in a printed journal, the advertisement includes an address (e.g. a telephone number or an URL) identifying a server system. The purchaser instructs a client system to request a code from the server system, e.g. by sending an SMS to the server system. The server system generates a code that identifies the advertisement and causes the code to be transmitted to the client system. The purchaser purchases a product that is related to the advertisement and provides the code to the shop at which the product is purchased. The shop then causes the code to be transmitted to the server system. The server system identifies the advertisement and performs a rating of the advertisement using information related to the purchase of the product. The rating can comprise information according to the number of sales that can be assigned to the advertisement, the total sales revenue, or the average advertising costs per product. According to a preferred embodiment of the invention, an optimisation of the advertisement is performed by changing at least one parameter related to the advertisement.

### BACKGROUND OF THE INVENTION

The present invention relates to a method for rating an advertisement and to a server system for facilitating the rating of the advertisement.

Advertising a product, a producer or an distributor of products can be performed by placing an-advertisement in a newspaper or a journal. Advertising can also be performed by broadcasting a commercial via television (TV) or radio.

Advertisements are usually intended to increase the profit by increasing the number of sales. Different advertising campaigns are frequently performed in parallel, e.g. commercials sent via TV at different times, several advertisements published in different journals, and several advertisements broadcasted via radio. However, publishing the advertisement in a journal or broadcasting the advertisement via TV produces costs. To be profitable and in particular to increase the sales revenue, advertisements have to be rated.

While it is possible to determine the costs of a specific advertising campaign i.e. a specific advertisement, it is difficult to determine whether the purchase of a product is caused by the specific advertisement. It is even difficult to determine, whether an increase or decrease of the number of sales of a product is really induced by the totality of the advertising campaigns. In particular, it is difficult to determine, how a modification of a specific advertising campaign influences the number of total sales. This makes it very difficult to decide, whether and how a specific advertisement should be optimised to increase the number of sales and in particular to improve the sales revenue.

To optimise the advertisements related to a product or a service it is known to cancel or replace one or more advertisements or to place new advertisements according to some kind of trial-and-error procedure.

To gain information about whether a product was purchased as a consequence of an advertisement, it is known to ask the purchaser about which advertisement caused him to purchase the product. Since this kind of questioning usually is voluntarily, only few purchasers answer these questions. In addition, purchasers often cannot remember, which advertisement caused them to purchase the product, possibly because of the delay between noticing an advertisement and purchasing the advertised product. Moreover, even if the purchaser gives an answer to this question, it can not be verified if it is in fact true.

### SUMMARY OF THE INVENTION

It is an object of the present invention to provide an improved method for rating an advertisement. In particular, it is an object of the invention to provide an improved method to determine, whether an advertisement caused the purchase of a product.

This object is achieved by the independent claims.

According to the present invention, an advertisement is presented to a purchaser. This can be done by broadcasting the advertisement via radio or television. It can also be done by publishing the advertisement in a printed journal, e.g. a newspaper or a magazine, or by showing a commercial in a cinema. The advertisement includes an address identifying a server system. The address can be for example a telephone number according to the fixed network or to a mobile telecommunication network. It is also possible, that the address represents a so called URL (uniform resource locator) according to the Internet.

The purchaser instructs a client system to issue the address. The client system can be for example a mobile telephone, a personal computer, or any device that enables the purchaser to communicate directly or indirectly (e.g. via another device) with the server system. If the client system is a mobile telephone, the address can be issued by sending a message, e.g. using SMS (short message service), to the server system. The message includes an address that identifies the client system. The server system then generates a code that identifies the advertisement and causes the code to be transmitted to the client system, e.g. using SMS or via email.

When the purchaser purchases a product that is related to the advertisement, the code is provided to the shop at which the product is purchased. The code identifying the advertisement is then transmitted to the server system.

The server system identifies the advertisement and performs a rating of the advertisement. The server system thereby uses information related to the purchase of the product, e.g. the sale price or the profit, which are provided e.g. by the shop or a merchandise information system that is assigned to the shop. The rating can include information concerning the number of sales that can be assigned to the advertisement, the total sales revenue, or the average advertising costs per product.

An optimisation of the advertisement is preferably performed by changing at least one parameter related to the advertisement. According to preferred embodiments of the invention, the parameter defines a time (e.g. the time and/or the date of broadcasting the advertisement or the duration of the broadcasted advertisement), a position within other advertisements, a channel, a specific program, a topic, a journal, the page or a journal, the position within a page, a graphical feature, or weather characteristics like the temperature or whether it is rainy, sunny, or cloudy, etc.

Further embodiments of the invention are provided in the dependent claims. In particular, it is emphasized that the invention may also be realized by a computer program or a computer program product which are able to execute the method in accordance with the invention when run on a data processing system.

The invention together with further objects, advantages, features and aspects thereof will be more clearly understood from the following description taken in connection with the accompanying drawings.

### BRIEF DESCRIPTION OF THE DRAWING

FIG. 1 is a schematic block diagram of main components of a first embodiment of the invention;

FIG. 2 is a schematic block diagram that shows the main components of a second embodiment of the invention; and

FIG. 3 FIG. 3 is a flow chart of an embodiment of the present invention.

### DESCRIPTION OF THE PREFERRED EMBODIMENT

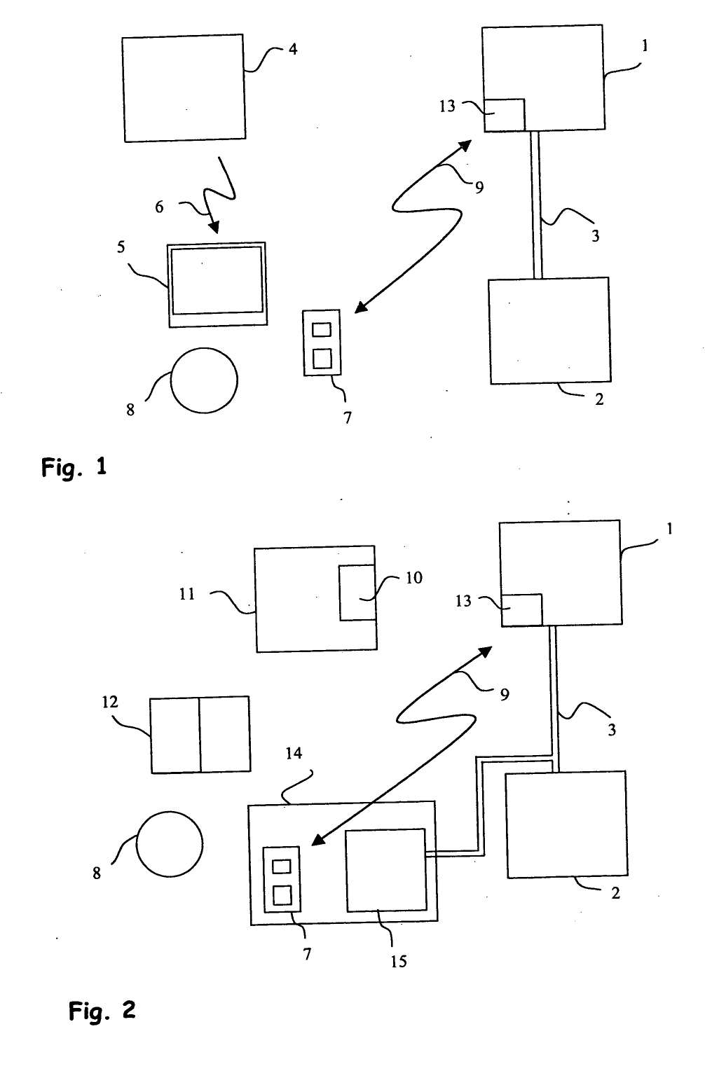

FIG. 1 shows a first embodiment of a system for optimising an advertisement. The system comprises a server system 1 and a shop 2. The shop 2 can be an online-shop. The shop can also be represented by a conventional retail shop. The shop 2 and the server system 1 are connected via a communication network e.g. the Internet 3. A broadcasting service 4 provides means for broadcasting a program to a receiver, e.g. a television set 5, via a transmission path, e.g. a radio link 6.

The system further comprises a client system, e.g. a mobile phone 7, that is assigned to a purchaser 8. The mobile phone 7 and the server system 1 are enabled to exchange data via a communication network, e.g. a mobile network 9.

In a modified embodiment of the system shown in FIG. 1, the broadcasting service 4 provides means for broadcasting sound radio via an adapted radio link 6. In this embodiment, the television set 5 would be replaced or complemented by a radio set.

An address 13 is assigned to server system 1 such that the mobile phone 7 can initiate establishing a data link between mobile phone 7 and server system 1, e.g. by using the mobile network 9. In general, address 13 can be a fixed network or mobile telecommunication network telephone number. It is also possible, that address 13 represents a so called URL (uniform resource locator) that permits identification of server system 1 and/or information provided by the server system, wherein the server system 1 is connected to the Internet 3. The client system, e.g. the mobile phone 7, can also be connected to the Internet 3.

FIG. 2 shows a second embodiment of a system for optimising an advertisement. The system also comprises server system 1, shop 2, and mobile phone 7 assigned to purchaser 8. Instead of the broadcasting service 4, the system shown in FIG. 2 comprises an advertising office 10 that is assigned to a publishing house 11. The publishing house 11 publishes a journal 12, which can be bought and read by the purchaser 8.

In the embodiment illustrated in FIG. 2, the mobile phone 7 is part of a client system 14. The client system 14 also comprises a computer system which can be realized by a personal computer 15. According to a preferred embodiment of the invention, the personal computer 15 is connectable to the Internet 3.

According to another embodiment of the present invention, the journal is published such that it can be viewed using a so called electronic paper technology, e.g. eBook. The publishing house 11 may also publish the journal via an appropriate memory device, e.g. a CD-ROM. Alternatively, the journal can be published via the Internet 3 and communicated to an electronic device for display thereof. The journal may also be a so called online-magazine which is published via one or more web pages that can be requested from the client system 14, e.g. the personal computer 15 or the mobile phone 7 and via the Internet 3. It is also conceivable, that the journal is published via the Internet 3 in another conventional file format, e.g. as a pdf-file, a ps-file, or a jpg-file.

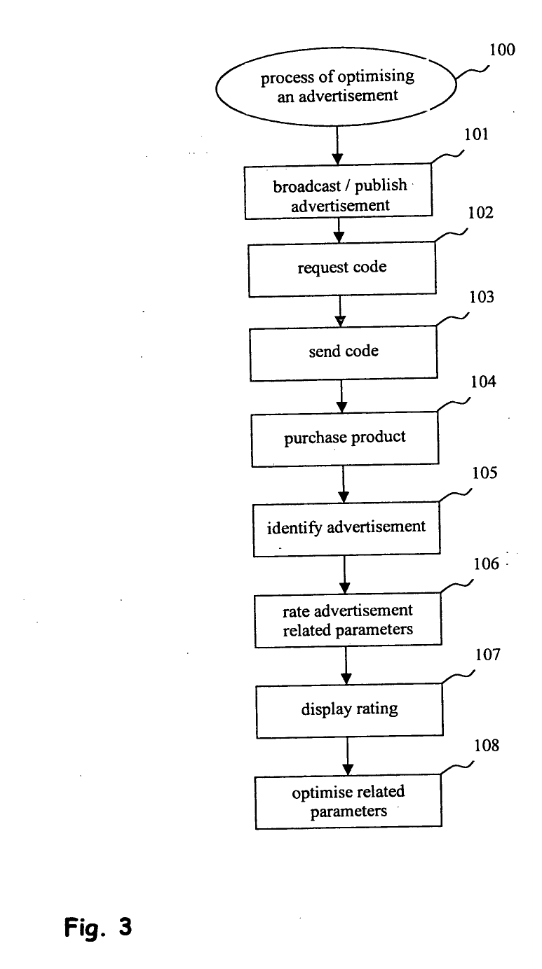

FIG. 3 shows a flow chart of an embodiment of the process 100 of optimising an advertisement according to the present invention. FIG. 2 also illustrates the mode of operation of the embodiments of the present invention as shown in FIG. 1 and FIG. 2.

In a step 101, the purchaser 8 takes notice of an advertisement. This can be done by watching TV and receiving the advertisement using the television set 5, wherein the advertisement is broadcasted (e.g. as a commercial) from the broadcasting service 4 using the radio link 6. If the advertisement is published in the journal 12 by the publishing house 11, the purchaser 8 takes notice of the advertisement when buying and reading the journal 12.

The advertisement includes information concerning a product that can be purchased or a service that can be ordered. The advertisement can also comprise information concerning a producer or a general distributor with or without explicitly referring to one or more products. Address 13 is displayed together with the advertisement. According to a preferred embodiment of the invention, the advertisement contains further information indicating that the purchaser 8 is allowed a discount when purchasing the advertised product or purchasing any product from an advertised producer or distributor. The discount can be realized by a reduction in the sale price. The discount can also be realized in the form of free gift, a credit or any other bonus that can be used as an incentive to buy.

In a step 102 the purchaser 8 requests a code from the server system 1 by sending a message to the server system 1. This can be done by sending a possibly empty SMS (short message service) to the telephone number that is shown on the advertisement as address 13. It can also be done by calling a call center that is assigned to server system 1 or by sending an email to the server system 1.

The server system 1 then generates a code that is assigned to the advertisement and thus can be used to identify the advertisement. In a preferred embodiment of the present invention, the code is assigned to a single advertising campaign, e.g. the broadcasting of an advertisement at a specified date and time, at a specified channel, at specific weather conditions, etc. Alternatively, the code is assigned to a predefined set of advertisements such that it identifies not a single advertisement but all advertisements out of the predefined set of advertisements. The set of advertisements can for example comprise all advertisements related to a specific product or some advertisements that are broadcasted via a specific TV-channel within in a predefined period of time.

The code generation can be performed in various ways known to one skilled in the art. Therefore, it may be helpful to assign a unique identifier for each advertisement or for each set of advertisements. Having such a kind of predefined advertisement identifier, the code can be realized as a numerical or an alpha-numerical string that consists of the predefined advertisement identifier. The code may also comprise further information, e.g. the time of the request, the actual value of a counter that counts each request according to the actual advertisement, the telephone number of mobile phone 7 or the like.

According to a preferred embodiment of the present invention, the server system 1 identifies the advertisement depending on the time the purchaser 8 requests the code. Therefore, it is conceivable that the purchaser 8 has to request the code from the server system 1 within a predefined period of time (e.g. 10 minutes) after the purchaser 8 has watched the advertisement on TV. If there are different advertisements that are to be optimised by the server system 1 or if the advertisement is broadcasted via different channels at nearly the same time, an identification of the appropriate advertisement can be ensured by using a different address 13 for each different advertisement, channel, program, etc., wherein all these addresses 13 are assigned to the server system 1. Thus, if the purchaser 8 requests a code, the server system 1 can identify the advertisement by evaluating address 13 (e.g. the telephone number) the purchaser 8 has used to send the request to the server system 1.

Alternatively, address 13 can be assigned to a set of advertisements, e.g. the advertisements that are broadcasted within a predefined period of time and not depending on the TV-channel that broadcasted the advertisement.

In another embodiment of the present invention, the server system 1 generates the code at random, e.g. by using a random number generator. The server system 1 assigns the code to the advertisement. To identify the appropriate advertisement, the server system 1 evaluates the time of the request and/or the address that was issued by the purchaser 8 using the mobile phone 7.

Server system 1 preferably generates the code by just selecting a predefined string that is already assigned to the advertisement and stored in a database.

According to another embodiment, the server system 1 realizes the generated code as a so called bar code. The bar code can be represented as an image according to a known graphic and/or compression format, e.g. jpeg, pdf, gif, and the like.

The server system 1 preferably stores the generated code in a database that allows the server system 1 to identify an advertisement according to a given code and to retrieve one or more codes that identify a given advertisement.

In a step 103, the server system 1 sends the code to the client system, e.g. the mobile phone 7 or the personal computer 15 that is assigned to purchaser 8. This is preferably done by SMS or by email. The client system 14, e.g. the mobile phone 7 or the personal computer 15 receives the code and stores it. If the code is represented as a bar code, it is also conceivable that the purchaser 8 causes the code to be printed on paper.

In a step 104 the purchaser 8 purchases a product at shop 2, wherein the product can be the product advertised via the advertisement or at least a product that is distributed by the advertised distributor or that is produced by the advertised producer.

According to a preferred embodiment of the invention, the shop 2 is a retail shop. The purchaser 8 goes into the retail shop and passes the code to the shop 2 at the latest when paying. This can be done by telling the cashier the code or by typing the code in a key pad that is provided at the cashier. If the code is stored on the mobile phone 7, the purchaser 8 can instruct the mobile phone 7 to display the code. If the code is a bar code, it is conceivable that the cashier scans it with an appropriate scanning device. The bar code can be scanned directly from the display of the mobile phone 7 or from a printed medium.

Alternatively, the code can be passed to the shop 2 using a data connection which connects the mobile phone 7 and a computer system attached to the shop 2. The data connection can be realized by a infra-red (IR) interface or by a bluetooth connection. The purchaser 8 can also instruct the mobile phone 7 to send the code to the computer system via SMS.

If the code allows the purchaser 8 a discount, the price of sale will be reduced accordingly. If the code allows the purchaser 8 some credit points, those points can be stored in an appropriate conventional manner.

According to another preferred embodiment of the present invention, the shop 2 is an online-shop. An online-shop is basically a computer system that is connected to a computer network, e.g. the Internet 3. For purchasing a product or ordering a service, a purchase order is sent to the online-shop from the client system 14 e.g. the personal computer 15 or the mobile phone 7 via the Internet 3. A computer software, e.g. a browser, is installed on the client system 14. The browser enables the client system 14, i.e. personal computer 15 or mobile phone 7, to send information to the online-shop and to display information received from the online-shop. The information that is sent from the online-shop to the client is frequently coded in HTML (Hypertext Markup Language) and transmitted as a so called Web page.

To contact the online-shop, the purchaser 8 types a unique address into the browser, wherein the unique address is assigned to the shop. Within the Internet 3 the unique address is called an URL (Uniform Resource Locator).

Depending on a request of the purchaser 8, the online-shop sends a Web page to the purchaser 8, i.e. to the client system 14, e.g. the mobile phone 7 or the personal computer 15, which enables the purchaser 8 to select and order a product or a service. When purchasing the product, the purchaser 8 instructs the client system 14 to transmit the code to the online-shop. If the code allows the purchaser 8 a discount, the price of sale will be reduced accordingly.

In a step 105, shop 2 causes the code to be send to the server system 1. This can be done via the Internet 3. Typically, the shop 2 also sends further information that is related to the purchase. This further information can include the price of sale, date and time when the purchase was accomplished and/or the margin.

The server system 1 receives the code together with the further information related to the purchase and identifies the advertisement. This can be done by sending a query to the database in which the code was stored in step 102. The code itself may also be written in a way that permits direct identification of the advertisement, i.e. without sending a query to the database. The code may thereby contain an ID that is assigned to the advertisement. Various algorithms for generating and storing such codes and various methods for coding and encoding an ID are known to one skilled in the art.

According to a further embodiment of the present invention, the purchaser 8 does not purchase a product but requests information related to the product or the producer that is advertised. This information can be requested from an information provider connected to the internet. The information can also be requested via a call center that is assigned to the producer, the distributor, or a shop that offers the product for sale. The information can e.g. be a sales brochure. If the purchaser 8 requests the sales brochure from the information provider, the purchaser 8 is allowed a discount, e.g. by donating an advertising gift.

In a step 106, server system 1 rates the advertisement based on the code and the further information that are sent from the shop 2 to the server system 1 in step 105. According to a preferred embodiment of the present invention, the rating comprises at least the determination of one or more of the following values:
advertising costs
profit when selling advertisement related products
sales volume
min/max/average time between broadcasting/publishing the advertisement and the purchase of a advertisement related product
ratio of code requests and purchases

These values are meaningful to determine, whether an advertisement is successful or not.

In a step 107, server system 1 makes the rating accessible to at least one authorized user, e.g. the shop 2, the producer of a product, the distributor of a product, and/or an advertising agency. The server system 1 thereby provides one or more accounts for each authorized user. The authorized user, or at least a client system that is assigned to an authorized user, logs into the account by passing a user identification and a password and queries the results of the rating. The server system 1 transmits the results of the rating to the authorized user. This can be done by sending a possibly dynamically generated web page. Alternatively, it is conceivable that the server system 1 sends an email to the authorized user that contains the results of the rating.

In a step 108 an optimisation is performed. The optimisation can comprise various different parameters related to the advertisement. These parameters can define the time when the advertisement is broadcasted or published, a topic, a graphical feature, etc. A graphical feature can describe the fonts of the text, the color of the text, whether pictures are included, which pictures are included, the scale of several graphic elements, and the like. The optimisation can also comprise parameters that are related to one or more weather characteristics. These parameters can describe the outside temperature, and/or whether it is rainy, cloudy or sunny. An optimisation that takes weather-related parameters into account can, for example, broadcast an advertisement only when it is likely to be rainy or cold.

If the advertisement is broadcast via TV or radio, the parameters can also define a channel, a program, the length of the broadcast or the position between other advertisements. If the advertisement is published in a journal, the parameters can define the journal, the page within the journal, the position on a page, the topics of surrounding articles and the like.

The optimisation increases the profit when selling one or more products that are related to the advertisement. This can usually be done by monitoring increases in the number of products that are sold as a result of the advertisement. Since the advertising costs decrease the sales revenue of each product, it can be a further goal of the optimisation to only increase advertisement costs if the resulting sales revenue increases to such an extent that the increased advertising costs are not higher than the increased profit.

Another parameter that can be considered when optimising the advertisement is the likelihood to be noticed by potential purchasers. This parameter depends on other parameters, e.g. the time when an advertisement is broadcasted, the channel that broadcasts the advertisement, and the position within other advertisements that are send e.g. in a break during a movie. Basically, the more people that take notice of the advertisement, the more people purchase a related product, assuming that a fixed rate of people that take notice of the advertisement purchase a related product. So, another parameter that can be optimised is the rate of people that purchase a product related to the advertisement when they have taken notice of the advertisement. For instance, advertising a product related to gardening is likely to be more effective if the advertisement is published in a gardening-journal than if it is broadcasted via TV during a break in a live broadcast of a motor vehicle event. Such a gardening related broadcast can also be more effectively broadcasted when it is warm and raining. This goes with the observation, that at low temperatures, e.g. in winter, a purchaser is less likely to purchase gardening products. On the other hand, if it is warm outside, e.g. in summer, fewer people watch TV and therefore can take notice of the advertisement. But if it is summer and raining, people are likely to buy gardening products and are more likely to be watching TV. Thus, advertising gardening related products during a rainy summer day may be most effective. Therefore, for placing an advertisement it can be useful to take the weather forecast into account.

The optimisation can be performed personally e.g. by an assistant associated to the server system 1 or the shop 2, respectively.

Alternatively, the optimisation can be performed automatically. This can increase the gain of the optimisation procedure, since more data can be taken into account for optimising the advertisement and the optimisation procedure can be performed faster.

To perform an automated optimisation, it is conceivable to develop an expert system that supports the optimisation process. For example, the expert system can hold for different combinations of parameters the likelihood of increasing the profit of a given product. Thus, if a product is given and maybe one or more fixed parameters (e.g. the type of the product, the industrial sector, the maximum advertisement costs, etc.), the expert system will suggest values for the remaining parameters (e.g. broadcasting via TV or publishing in a journal, TV-program, broadcasting time, channel, page of journal, position within other advertisement, etc.).

The expert system is also preferably able to suggest mixed strategies, e.g. to define more than one advertising campaigns for one product that has to be advertised, wherein the advertising campaigns can be performed in parallel. This means for instance, that an advertisement is broadcasted via different channels in different programs, attached to different movies that are shown in one or more movie theatres, and published in one or more print media. For each advertising campaign the expert system can provide the corresponding set of parameters.

The expert system can be implemented as a rule-based expert system i.e. by providing predefined rules in a knowledge base. The expert system is preferably designed to be self-adapting. This can be realized by storing the set of parameters for each advertisement in the knowledge base accompanied by the results of the rating. Whenever new ratings are available, the knowledge base is updated. The expert system uses the knowledge stored in the knowledge base to perform the optimisation, i.e. the predefined rules together with parameters of advertisements that are already rated and/or optimised. The implementation of automatic optimisation, e.g. the expert system, can be realised in software using various different tools and/or libraries that are known to one skilled in the art.

The structure of server system 1, the structure of the optimisation process as described in FIG. 3, and the functionality of the expert system is just one example to illustrate the invention by describing embodiments of the invention. It is known to one skilled in the art to realize the server system 1, the shop 2, the broadcasting service and the client system 14 in various different ways. It is for example conceivable that the server system 1 and the shop 2 are realized on the same computer system or that the server system 1 and/or the shop 2 are distributed among various different computer systems.

According to a preferred embodiment of the present invention, the code is generated in step 102 to be unique. A purchaser 8 may request the code and distribute it to other additional purchasers. If each code is unique and only passed once from the server system 1 to a purchaser 8, it enables the server system 1 to determine whether a code is used more than once when purchasing a product. Passing each code only once from the server system 1 can thus cause a refinement of the rating of an advertisement, e.g. by illustrating, how many purchases of a product are caused by different purchasers 8. The server system 1 can also ensure, that for each code passed from the server system 1 a discount is given only once.

According to another preferred embodiment of the present invention, an identification (UID) of the purchaser 8 and/or the client system, e.g. the mobile phone 7, is sent to the server system 1 in the step 102 when the code is requested from the server system 1. The UID can be for example the telephone number that is assigned to the mobile phone 7 which can be sent automatically to the server system 1 when requesting the code. The code generation can then be performed such that the UID and the identification of one or more advertisements can be deduced from the generated code. The UID and/or the advertisement identification may thereby be input to the code-generating algorithm. The server system 1 could also generate a code that neither incorporates the UID nor the advertisement identification. Instead, the code is stored in a data base assigned to the server system 1 such that the code can be associated with the UID and the advertisement identification. This enables the server system 1 to perform an even more precise rating of the advertisement, e.g. by illustrating how many different users have purchased a product according to taking notice of a specific advertisement or an advertisement out of a predefined set of advertisements. It also enables the server to organise different incentive programs, e.g. by allowing additional discounts to purchasers 8 that purchase a large number of products.

According to a further preferred embodiment of the present invention, the receiver, e.g. television set 5, and the client system 14, e.g. the mobile phone 7 are connectable to a communication network, e.g. an ad-hoc network based on a bluetooth data connection. The broadcasting service 4 attaches a messages to the advertisement that is received from the receiver and transmitted to the client system via the ad-hoc network. The message can be displayed on the client system 14 and asks the purchaser 8 to request the code from the server system 1. The request can be performed by simply pressing a defined button.

The code may also be transmitted from the server system 1 to the broadcasting service 4. The broadcasting service 4 attaches the code to the information that represents the advertisement and transmits it to the receiver, e.g. the television set 5. The receiver and the client system 14 can be connected to each other via a communication network. The receiver or the client system 14 displays a message that asks the purchaser 8 to request the code, possibly by simply pressing a button. The code is then transmitted from the receiver to the client system 14.

1. A method for rating an advertisement, the method comprising the steps of:
a) presenting the advertisement and an address related to a server system to a purchaser;
b) addressing the server system using the address and requesting a code from the server system using a client system instructed by the purchaser;
c) automatically transmitting an automatically generated code from the server system to the client system, wherein the code identifies the advertisement;
d) purchasing a product related to the advertisement at a shop and providing the code to the shop;
e) transmitting the code to the server; and
f) rating the advertisement using the server system using information related to the purchase of the product.

2. The method of claim 1, further comprising optimising performance by changing at least one parameter related to the advertisement.

3. The method of claim 1, wherein the code is provided to the shop using the client system.

4. The method of claim 2, wherein the advertisement is announced via a broadcast.

5. The method of claim 4, wherein at least one advertisement related parameter defines a broadcast channel.

6. The method of claim 4, wherein at least one advertisement related parameter defines a program.

7. The method of claim 2, wherein the advertisement is published in a journal.

8. The method of claim 7, wherein at least one advertisement related parameter defines the journal.

9. The method of claim 7, wherein at least one advertisement related parameter defines a page within the journal.

10. The method of claim 2, wherein at least one advertisement related parameter defines a time.

11. The method of claim 2, wherein at least one advertisement related parameter defines a date.

12. The method of claim 2, wherein at least one advertisement related parameter defines a topic.

13. The method of claim 2, wherein at least one advertisement related parameter defines a position within a set of advertisements.

14. The method of claim 2, wherein at least one advertisement related parameter defines a graphical feature of the advertisement.

15. The method of claim 2, wherein at least one advertisement related parameter defines a weather related characteristic.

16. The method of claim 1, wherein the information related to the purchase of the product comprises a sale price of the product.

17. The method of claim 1, wherein the information related to the purchase of the product comprises a profit of the purchase.

18. The method of claim 1, wherein the information is extracted from a merchandise information system and is related to the shop.

19. The method of claim 1, wherein the client system is a mobile telecommunication system.

20. The method of claim 1, wherein the purchaser is allowed a discount when purchasing the product and providing the code.

21. The method of claim 1, wherein the code is provided to the shop as a bar code.

22. The method of claim 1, wherein the server system provides an actual rating and at least one parameter related to the advertisement to an authorized user.

23. The method of claim 1, wherein the rating of the advertisement in step f) is performed in dependence on advertising costs.

24. The method of claim 1, wherein the server system generates the code in dependence on a time of the client system's request.

25. The method of claim 1, wherein the server system generates the code in dependence on a date of the client system's request

26. The method of claim 1, wherein the address related to the server system is a telephone number.

27. The method of claim 1, wherein the address related to the server system is a uniform resource locator (URL).

28. The method of claim 1, wherein the purchase is induced using the client system.

29. The method of claim 2, wherein the performance is automatically optimised by the server system.

30. The method of claim 29, wherein the performance is optimised using an expert system.

31. A server system for facilitating optimisation of an advertisement, the server system comprising:
means for generating and transmitting a code to a requesting client system, wherein the code identifies an advertisement;
means for receiving the code from a shop;
means for identifying the advertisement according to the received code;
means for receiving information related to a purchase of a product, wherein the information is issued from the shop and the product is related to the advertisement; and
means for rating the advertisement using received information related to the purchase of the product.

32. The server system of claim 31, further comprising means for optimising the advertisement by changing at least one parameter related to the advertisement.

33. The server system of claim 31, further comprising means for identifying the advertisement depending on a request time of the client system.

34. The server system of claim 31, further comprising means for identifying the advertisement depending on an address the client system issues when requesting the code.

35. The server system of claim 31, further comprising means for providing an actual rating and at least one parameter related to the advertisement to an authorized user.

36. The server system of claim 31, further comprising means for automatically optimising the advertisement.
